(19) United States
(12) Patent Application Publication
(10) Pub. No.: US 2022/0337642 A1
(43) Pub. Date: Oct. 20, 2022

(54) CUSTOM VIRTUAL EVENT PLAYLISTS

(71) Applicant: AT&T Intellectual Property I, L.P., Atlanta, GA (US)

(72) Inventors: Keith Aubrey Crowe, AUSTIN, TX (US); Charles V. Scott, Austin, TX (US)

(73) Assignee: AT&T Intellectual Property I, L.P., Atlanta, GA (US)

(21) Appl. No.: 17/230,668

(22) Filed: Apr. 14, 2021

(51) Int. Cl. H04L 29/06; G06F 16/435; G06F 16/438; G06F 3/01

(52) U.S. Cl. CPC H04L 65/4076; H04L 65/1073; G06F 16/437; G06F 16/4387; G06F 3/013

(57) ABSTRACT

Aspects of the subject disclosure may include, for example, registering a user to participate in a virtual event; creating a user playlist for user participation in the virtual event, the user playlist including a sequence of segments to be presented to the user in an immersive experience of the virtual event; providing a segment of the sequence of segments to the user in the immersive experience; detecting a user response to the segment; and modifying the segment for future presentations of the segment, wherein the modifying is based on the user response to the segment. Other embodiments are disclosed.

### FIELD OF THE DISCLOSURE

The subject disclosure relates to custom virtual event playlists for user participation in a virtual event.

### BACKGROUND

Various events such as conferences and concerts enable large groups of people to attend in-person and enjoy the benefits of meeting together in a common space.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a method that may be implemented within the communication network of FIG. 1 in accordance with various aspects described herein.

FIG. 2B is a block diagram illustrating an example, non-limiting embodiment of a system functioning within the communication network of FIG. 1 in accordance with various aspects described herein.

FIG. 2C depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a virtual, tiered, integrated event experience for an end user, where the user can select various experience levels in a virtual environment. The event may be experienced, for example, with virtual reality (VR), augmented reality (AR) or extended reality (XR) devices including video and audio presentation. This enables a user to attend an event virtually and experience customized aspects of the event without the requirement to travel to the event and be physically present at the event. Users may create their own experiences and share those experiences with others. Businesses and vendors may create virtual product demonstrations or experiences for the attendees of the event. Other embodiments are described in the subject disclosure.

One or more aspects of the subject disclosure include registering a user to participate in a virtual event; creating a user playlist for user participation in the virtual event, the user playlist including a sequence of segments to be presented to the user in an immersive experience of the virtual event; providing a segment of the sequence of segments to the user in the immersive experience; detecting a user response to the segment; and modifying the segment for future presentations of the segment, wherein the modifying is based on the user response to the segment.

One or more aspects of the subject disclosure include retrieving user information for a user participating in a virtual conference, creating a user playlist for the user for the virtual conference, including arranging a sequence of conference segments to be presented to the user in an immersive experience of the virtual conference. Aspects of the subject disclosure further include providing data defining a segment of the sequence of conference segments to immersive experience hardware of the user, detecting a user response to the segment, including detecting a user gaze of the user within the immersive experience hardware of the user, automatically modifying the segment based on the user response, forming a modified segment, and storing data defining the modified segment.

One or more aspects of the subject disclosure include registering a user to participate in a virtual event, including receiving user information about the user at a website, and selecting, by the processing system, a plurality of event segments based on the user information, the plurality of event segments to be presented to the user in an immersive experience of the virtual event through immersive experience hardware worn by the user, arranging the plurality of event segments into a user playlist, the user playlist forming an itinerary for user participation in the virtual event. Aspects of the subject disclosure further include selecting one or more advertisements to be presented to the user in an immersive experience of the virtual event, wherein the selecting one or more advertisements is based on the user information about the user, determining that the user has viewed at least one event segment of the plurality of event segments, initiating sending a prize to the user in response the determining that the user has viewed at least one event segment.

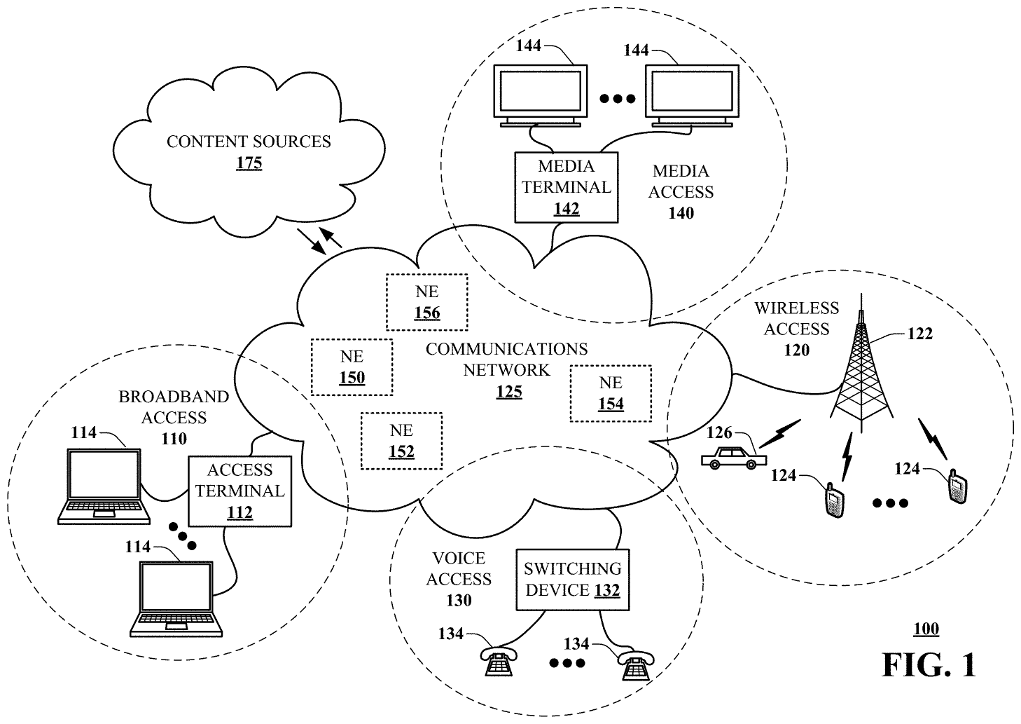

Referring now to FIG. 1, a block diagram is shown illustrating an example, non-limiting embodiment of a system 100 in accordance with various aspects described herein. For example, system 100 can facilitate in whole or in part enabling a user to virtually attend an event such as a conference or concert without being physically present in a space with other attendees. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or another communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

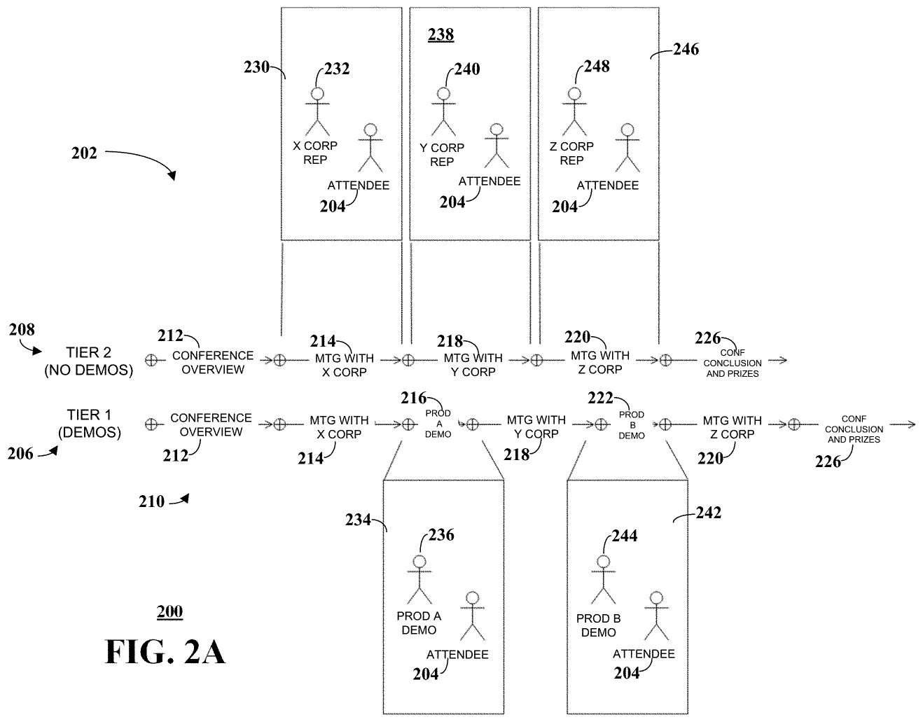

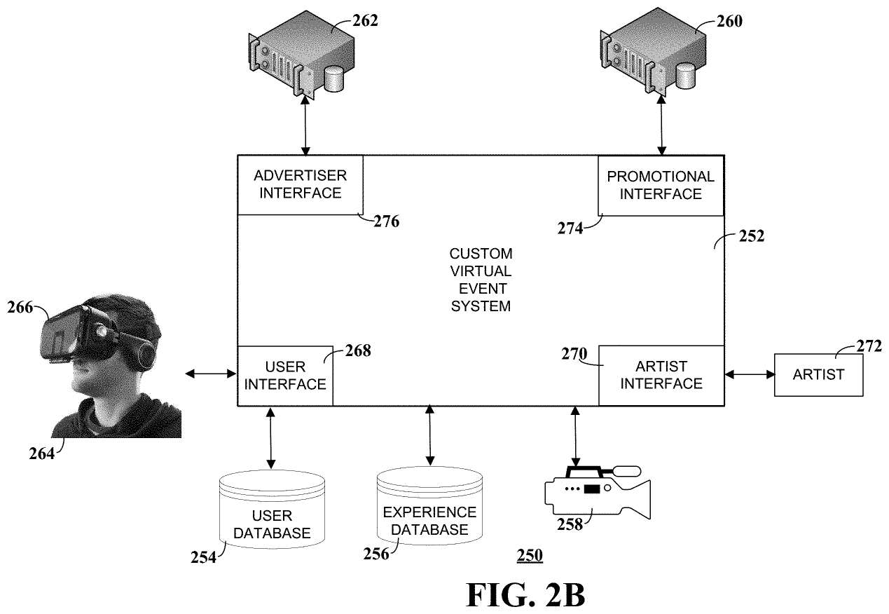

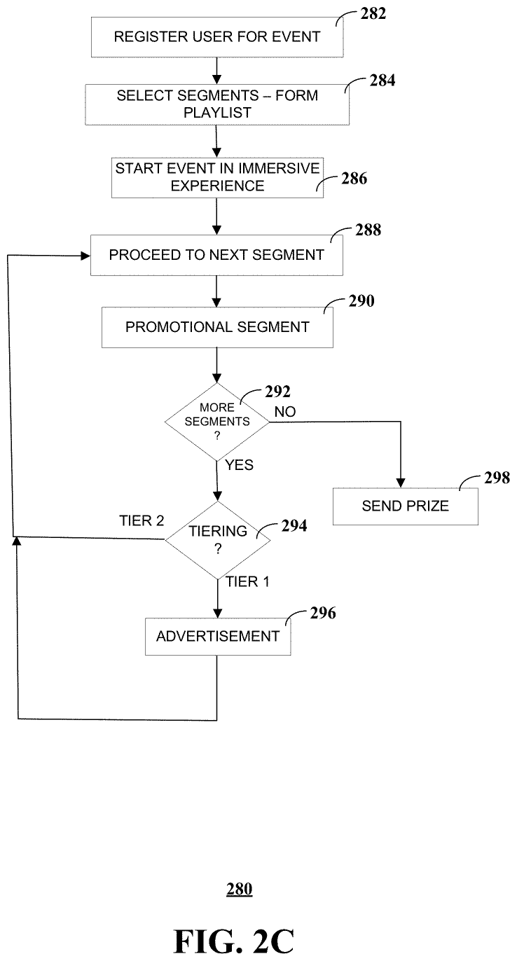

FIG. 2A is a block diagram illustrating an example, non-limiting embodiment of a method 200 that may be implemented within the communications network 125 of FIG. 1 in accordance with various aspects described herein. The method illustrates attendance at a virtual conference 202 by an attendee 204 who participates in the virtual conference 202 virtually.

For years, people have gathered in person at organized conferences to meet and discuss business and other mutual interests. A person with an interest in the topic of a conference can meet other people with similar interests as well as vendors of products and services that are related to the interest. Such conferences provide an intensive opportunity to meet and interact with other people having similar interests or working in the same field of endeavor. Contacts are made and ideas are exchanged among the attendees. A substantial convention business infrastructure has developed in order to bring such people together in a common location to meet and exchange ideas. This infrastructure includes travel, lodging and event facilities such as conference centers and entertainment venues.

Due to concerns over the global COVID pandemic and other reasons such as cost and difficulty of travel, opportunities to attend group gatherings for events such as live concerts, sports, or business conferences have become limited. This change has not only affected the attendees, but also the businesses who participate at the event, and the people putting on the event. Not only do the attendees miss out on the experience, the businesses and vendors that would participate also lose out on advertising, product demonstrations, etc. There is no event and no attendees to view their products. The same is true of other types of large gatherings including conferences, concerts, fairs, sporting events, rodeos, and circuses, for example. And it is expected that a similar situation will continue as potential attendees' willingness and ability to travel and attend large events is slow to recover.

Embodiments in accordance with various aspects described herein duplicate the experience of actual attendance at an event as closely as possible to the original, in-person experience. Some embodiments use immersive technology to recreate an event for an attendee. Immersive technology includes equipment such as headsets, smart glasses, audio speaker systems and computer control to create immersive experiences. For example, augmented reality (AR) systems use technology such as an AR headset and the camera and screen on a smartphone or tablet or other computer to add a computer-simulated layer of information on top of real-world features. AR technology is an enhancement of the world surrounding the user. Virtual reality (VR) goes a step further and immerses the user in a wholly artificial world, a digital simulation and creation with which the user can interact. A VR system will seek to stimulate as many user senses as possible to immerse the user in the simulated environment. Extended reality (XR) refers to environments that combine real and virtual environments and permit human and machine interactions. An XR environment may be generated by computer equipment and may be implemented by wearable technology such as a headset or AR glasses. XR technology may be considered to incorporate AR, VR, and other technologies for immersive experiences. As used herein, an immersive environment, an immersive experience, an XR environment, and a scene generally refer to a combination of real and virtual environments, AR and VR and others, for a user under automatic machine control.

Some embodiments in accordance with various aspects described herein include the creation of unique, virtual experiences that can be attended virtually by a user. In one example, the user accesses an online source such as a web site and there selects or defines an experience of their choice. In one embodiment, the user builds a unique experience or playlist of individual experiences from a group of selections. These virtual experiences include actual experiences presented to the user from the point of view of someone who was physically at the event. These experiences are captured via audio and video directly from the point of view of the individual attending the event, and then stored for use in other experiences. The experiences are presented to the user in any suitable format, such as via VR or AR or XR while the user accesses suitable VR AR or XR equipment such as a headset or goggles.

A user, in the role of attendee, creates a complete user experience of the event, prior to viewing the experience, in any suitable fashion. In a first example, the user accesses a web site associated with the event. The web site proves a list of available experiences which the user may select for subsequent viewing. The user manually selects direct specific experiences of interest to the user. The user's selections are saved and later presented to the user. In a second example, the user answers a set of questions about interests of the user. In response to the user's answers, the web site or other source selects a lineup or playlist of content items or experiences of interest to the user. In a third example, an experience is automatically generated for the user by the web site or other device based on user information collected about the user and available to the web site or other source.

In one example, the experience of interest to the user is a virtual technology conference. At a real-world conference, many users attend along with vendors of goods and services and presenters. The conference creates an environment in which attendees, vendors and presenters can meet and exchange ideas, in person. The virtual technology conference largely duplicates this experience, without the need to attend in person. The user selects specific participants the user wants to engage with during the virtual conference. Examples are tech companies the user is interested in learning more about or currently works with. Selections may be made, for example, by accessing a web site associated with conference.

The contents of the virtual conference are then automatically generated for the user. During presentation or playback of the virtual conference, the user wears an XR headset, for example. Within the XR experience presented to the user of the virtual conference, the user virtually walks the tradeshow floor, experiencing visually and audibly what an actual attendee at the actual conference would experience. For example, the user proceeds through the conference areas in the virtual world. The user visits tech companies and other participants in the conference. The user meets with representatives of different companies and may experience a demonstration of a product or service that the company seeks to promote at the conference.

Some embodiments include tiered levels which provide different experience. For example, a basic level may include advertisements of paid promotions to be viewed by the user. As the user passes through the virtual conference in the XR experience, the user may be shown virtual advertising. The virtual advertising may be in the form of advertisements that interrupt the XR experience, commanding the user's attention for a set time such as 15 seconds or 30 seconds or one minute. Alternatively, the virtual advertising may be more integrated with the virtual experience. In an example, within the XR experience, the user views a wall of the conference center hosting the virtual conference. The user is shown an advertisement on the otherwise blank wall. However, advertisements are shown, the advertisements may be selected based on recorded interests of the user or based on paid placement of the advertisements, such as by participants in the conference. Such virtual advertising is thus customized for the user. Another user, within a customized experience for that other user, may see other ads selected for the other user based on the interests of the other user.

In another example of virtual advertising, the user's virtual journey through the conference may be interrupted by a stop at a virtual booth of the conference. At the virtual booth, within the XR experience, the user may be exposed to a virtual product demonstration on similar technologies that line up with expressed preferences of the user. Based on information known about the user, the advertisements and presentations can be highly customized to the user to capture the attention of the user and deliver the message of the advertiser most effectively.

In another example, the user may qualify for a higher tier of virtual experience or an experience which includes less advertising. For example, if the user paid for admission to the conference, payment of a higher admission charge or additional fee may qualify the user to be upgraded to an additional price tier. In the higher price tier, the user is not shown any other advertising or is not exposed to product demonstrations within the virtual experience. The user in the higher tier may be only shown what the user has selected to see.

In another example, the user attends a virtual concert presented to the user by the XR equipment. In one embodiment, the user selects certain bands or songs that the user is interested in hearing and seeing to form a playlist for the concert. The user then experiences a virtual conference based on the user selections and preferences. In an embodiment, the user is offered tiered access to these virtual concerts. In tiered access, the user experience appears to originate in different virtual seats for the experience based on the tier. A first, lowest-cost tier may appear to place the user in the balcony of a theater. A second, higher-cost tier may appear to place the user in the front row of the theater. Thus, a user vantage point for the concert is determined based on tiering information. Other examples are possible, such as offering to the user a back-stage experience where the user gets to virtually meet the band or other artist. Other more personal experiences may be provided according to the tiered access, as well.

Like the virtual conference experience, the virtual concert area may also have virtual advertising and virtual product demonstrations for the user to interact with. This is a virtual version of the availability of product kiosks at actual concerts. In an embodiment, the user may play a game to win a prize, or answer a few questions, or other possibilities. Such features in the virtual experience serve to mimic the actual concert-going experience and add to the entertainment of the user. Such additional features may be chosen based on expressed interests of the user or a user profile. In a further embodiment, the user is presented with a virtual commercial or advertisement between the songs. In embodiments, the user has the option to upgrade to an additional price tier. In the higher-price tier, the user is not shown any additional virtual advertisements or product demonstrations.

In a further embodiment, a user may concatenate selected experiences, to produce a virtual play list. The virtual play list may be shared by the user with friends or co-workers of the user, or by means of any social media platforms. The ability to share a concert experience gives others the same user experience for them to enjoy. In a further embodiment, the other user who receives the virtual experience shared by the original user may modify the experience to customize the virtual experience according to interests or preferences of the other user. For example, the other user may remove specific experiences or add additional experiences to the overall shared virtual experience.

In embodiments, one or more virtual reality or augmented reality experiences may be recorded for playback to users. In an example, a person responsible for recording the experiences visits each company or sponsor or promoter attending the virtual conference. In one example, an actual live conference is presented with a combination of some actual attendees and some virtual attendees. The recorder moves through the premises of the conference and interviews a representative of each company or others wishing to engage with the virtual attendees. The interviews are recorded for playback and a user may select recorded interviews and add them to a playlist for playback. In some instances, rather than recording the interviews, the interviews are conducted live, in real time, and the user may view the live interview and even submit questions for the interview. In another example, the recorded interviews may be supplemented with materials provided by the companies, sponsors and promoters attending the conference. For example, a company's recorded presentation for the conference may include a recorded interview with company personnel present at the company's booth or kiosk at the conference plus a virtual reality experience viewable by the user in which the company's product or service is demonstrated or promoted. The user can add these items to a playlist for playback at the user's remote location. In a separate example, the conference is attended only by companies, sponsors or promoters and a recorder visits each company, sponsor and promoter and records the interview or other presentation for viewing by virtual attendees.

In an embodiment, the interviews and other material are recorded in XR format for viewing using suitable XR equipment. However, for viewers who lack the specialized equipment, the interviews and other material may be viewed in other formats, which may be selectable by the view, such as compressed mp4 video or other formats as well. Such other formats may then be viewed in a wide variety of devices.

A virtual concert experience may be recorded from different vantage points, such as the balcony of a theater, the front row in front of the stage, onstage at the side of the stage and in the middle of the auditorium. The user may select a vantage point for viewing the recordings and such selection may be subject to tiered costs. Each song performed by the artist may be individually recorded. The virtual attendee may select songs to form a playlist. The XR system may be interactive in that the artist can take requests and the viewer can submit requests, such as by calling out a song title. The user's voice speaking the song title is used to select from the playlist and play back the recorded song. The embodiments for a virtual concert may be extended to any suitable entertainment event, including examples such as a live play onstage, dance, a circus, a rodeo, ballet, opera or a lecture.

In another embodiment, an artist performs live and users participate virtually. The users may submit requests or vote as a group on a next song to play or other aspect of the performance. Any suitable interaction may be enabled between the artist and audience members and may be subject to tiered cost.

In another example of interaction, users are awarded prizes or other items, similar to swag that is given out at a live conference. In an example, the user views an interview with a representative of a presenting company at a virtual conference. The viewing is done remotely use XR equipment as the user attends the conference virtually. After the user views the interview, the user may further view a XR experience with a presentation of product features. Since the presentation is an immersive experience in virtual reality, the user can be made to feel immersed in the experience, such as appearing to be inside the product or transported to a different time and place to experience the product. After viewing the presenting company's materials, the user is invited to register with the company and receive a prize. The user enters registration information, such as name and email address. In an example, the user navigates to a web site associated with the presenting company to provide the registration information. In return for the registration information, a prize is automatically sent to the user. In an example, the prize is in the form of a coupon or voucher that is sent to the email address entered with the user's registration information. In another example, the user's registration information includes a home or business address, and a physical promotional object is sent to the home or business address included in the registration information. The promotional object may be sent by mail or courier delivery. The promotional object may be any suitable promotional material such as a thumb drive, a mouse pad, a tote bag, perhaps bearing the name or logo, or both, of the presenting company. The promotional material may be accompanied by other materials as well, such as product literature. Viewing the virtual conference and providing registration information or other information by the user results in sending the promotional item to the user. In other examples, the user may be asked to view a product demonstration in exchange for the prize or games of skill or chance may be made available for the user's entertainment, along with the chance to win prizes. Any suitable virtual reality game may be presented to the user.

In the embodiment of a virtual concert, promotional material may be provided as well. For example, a user attending the virtual concert may be prompted to provide registration information including a mailing address and email address. In return for the registration information, a promotional item may be sent to the user. The promotional item may be a virtual item such as a coupon or a data file including a recent song by the musical artist giving the virtual concert. Further, the promotional item may be a physical item mailed to the user, such as a compact disk (CD) or garment such as a shirt or hat. Viewing the virtual concert and providing information by the user such as registration information results in receipt of the promotional item by the user. In other embodiments, games of skill or chance may be made available at the virtual concert for the user's entertainment, along with the chance to win prizes for participating in the games. Any suitable virtual reality game may be presented to the user.

In another example, a system that manages access to the virtual experiences collects information about the user's interests. In one embodiment, the user is presented with an online form and invited to provide information about the user's interests. The form may include multiple checkboxes for different categories of information or space for the user to enter user interests, such as by using a keyboard. The information is automatically collected and stored for subsequent use. In another example, the system collects information about the user from various sources. For example, a browsing history for the user on one or more computer devices may be mined for information about the user's interests. Any other suitable source of user information may be accessed and the information stored for subsequent use.

As the user is engaged in the virtual experience, the system may collect user information about the user's response to the virtual experience. Any appropriate technique for monitoring user engagement or response may be used to collect information about the user. For example, the XR headset or other user equipment may monitor the user's gaze, or where the user's eyes are focused to learn about the user's interest. If the user's eye gaze wander during a product demonstration in the virtual environment, the system may conclude the user does not have a strong interest in the demonstrated product. Similarly, if the user is raptly focused on the product demonstration, it can be concluded that the user is highly interested. The system may use conclusions about user interest to provide additional promotional materials or product literature. Further, the system may use information about user interest to automatically modify the product demonstration. For example, if a substantial percentage of users become inattentive during a portion of the product demonstration, the system and the presenting company associated with the product demonstration may conclude that that portion is not effective and may modify that portion of the demonstration. Any suitable modification may be made to the virtual product demonstration to make it more interesting to user, such as by changing the appearance or duration of the portion, or the portion of the product demonstration may be omitted in future demonstrations. In another embodiment, if the user's attention is focused on a particular object in the virtual experience, the object may be brought into the foreground or brought closer to the user to allow the user to see the object in more detail.

In the case of a user viewing a performance, the user's focus of attention may be used to adapt the presentation of the virtual performance. A user viewing a virtual concert may be particularly interested in the guitar player in the band performing the concert and therefore watches the guitar player closely. The system may detect the focus of user attention and provide extended closeups of the guitar player's hands during songs or portions of songs. This feature may also be aligned with aspects of the performance. In an example, if the guitar player has a solo during a song, the virtual presentation may be adapted based on the user's interest in the guitar player to present a close view of the guitar player during the solo. In another example, the system determines during a virtual presentation of a play that the user is particularly focused on a physical aspect of the production, such as a prop onstage. As the prop is engaged with by actors in the production, the system may modify the view of the prop based on the user's detected interest. For example, the prop may be shown in closeup, or illumination of the prop may be modified, or the sharpness of the focus of images of the prop may be modified based on the detected user's interest.

Thus, the presentation of the virtual experience may be dynamically varied based on detected user response to the virtual presentation. Further, information about the reactions of multiple users may be collected and used to modify the presentation of the virtual experience in the future. Such collected information may relate to enthusiasm of users, interest of users, reactions of users, and user desire to learn more. Moreover, a product that is demonstrated may be modified based on the collected information.

The user information may be used to automatically prepare an itinerary for the user through the virtual conference. Any suitable matching algorithm, including artificial intelligence or machine learning, may be used by the system to associate user interests and presentations available at the conference. For example, if the user information indicates that the user has a particular interest in artificial intelligence (AI), the system will prepare an itinerary for the user that exposes the user to presentations or interviews with personnel associated with presenting companies who provide AI software tools and AI analysis tools. In other embodiments or in addition, the user may be presented with a list of presenting companies that are attending the virtual conference and given the opportunity to manually add presentations or visits with those presenting companies.

In some embodiments, the user information may be used to select and prepare advertising to show to the user inside the virtual experience. Any suitable matching techniques, such as keyword matching, may be used to determine appropriate advertising for the user. In some embodiments, the system or an associated advertising server may conduct an auction among advertisers for the opportunity to show the advertising to the user in the virtual experience. The advertising may include providing product demonstrations to the user. The provision of advertising may be subject to tiering in that users may select a higher tier in which advertising is not displayed or in which less advertising is displayed. In some embodiments, some advertising is mandatory, and the user may not opt out of the mandatory advertising. The user may select a higher tier by, for example, paying a higher fee to register for a virtual conference or paying a higher admission price for entry to a virtual concert or other entertainment.

Referring to FIG. 2A, the drawing figure illustrates an exemplary embodiment of attendance at a virtual conference 202 by an attendee 204. The participation of the attendee 204 is according to an itinerary. The attendee 204 represents a user accessing the virtual conference 202 using, for example, XR equipment. Thus, activities that the attendee 204 experiences in the virtual world of the virtual conference 202 are experienced by a human user in an immersive experience provided by the XR equipment.

The attendee 204 has a choice of two attendance tiers for the itinerary. A first tier 206, labeled tier 1 in FIG. 2A, provides the attendee 204 with the opportunity to experience product demonstrations (“demos”) during attendance at the virtual conference 202. A second tier 208, labeled Tier 2 in FIG. 2A, omits demonstrations from the itinerary. Other tier options may be provided as well.

In general, the demonstrations are an opportunity for a seller of a product or service to promote the product or service. The seller may pay to the organizer of the virtual conference 202 a promotional fee for the opportunity to engage with attendees such as attendee 204 at the virtual conference 202. The promotional opportunity provided by the virtual conference 202 may be highly valuable to the seller because it presents a chance to meet existing or potential customers who are known to be actively interested in information about the promoted product or service, by virtue of their attendance at the virtual conference.

The attendee 204 may prefer to experience the product demonstrations or may prefer to avoid the product demonstrations. The tiers, first tier 206 and second tier 208, provide the opportunity to choose. In an embodiment, when the attendee 205 registers to participate in the virtual conference 202, the attendee 204 elects first tier 206 or second tier 208. Registration may be accomplished, for example, through a web site offered by the organizer of the virtual conference 202. The organizer of the virtual conference 202 may charge a higher registration fee for the opportunity to avoid the product demonstrations. FIG. 2A illustrates two tiers, first tier 206 and second tier 208. In other embodiments, any number of tiers may be specified by the organizer of the virtual conference 202 or may be selected by the attendee.

In the embodiment of FIG. 2A, activities for the attendee 204 are arranged as an itinerary 210. The itinerary 210 is generally the same for both the first tier 206 and the second tier 208. One difference between the first tier 206 and the second tier 208 is the inclusion of product demonstrations in the itinerary of the first tier 206. In other embodiments, the itinerary may include other features and other differences between tiers.

In a first embodiment, the itinerary includes items, meetings presentations and other segments selected by the attendee 204. For example, when the attendee 204 registers for the virtual conference 202, the attendee may select the segments to be included in the itinerary. The segments may be listed on a web site for selection by the attendee or by any suitable method. The segments may then be arranged into the itinerary 210 either by the attendee or automatically by a system which implements the virtual conference 202. In another embodiment, at least some segments are selected for the attendee 204 based on information about the attendee 204. For example, the system which implements the virtual conference 202 may have access to user preference information or a user profile and may make segment selections for the itinerary 210 based on that information. Further, the system which implements the virtual conference 202 may select on or more product demonstrations for the attendee to view. Such product demonstrations may be omitted if the user selects the second tier 208. Still further, the system which implements the virtual conference may select one or more advertisements or promotions to be shown to the attendee in the virtual experience as the attendee progresses through the itinerary 210. The selected advertisements may be selected based on any available information, such as a user profile, past user activities such as product interest, and so on.

The itinerary 210 for both the first tier 206 and second tier 208 initially includes a conference overview 212. The conference overview 212 is an initial immersive experience for the attendee 204 who is participating in the virtual conference 202. The conference overview 212 may include any suitable content, presented in any suitable manner. In an example, the conference overview 212 is presented on XR equipment such as an XR headset for viewing and hearing by the attendee 204. The content may include video and graphics and audible features such as music. The content may include one or more speakers discussing the virtual conference 202 and providing information about presenters at the virtual conference 202. In the example, the conference overview is pre-recorded with audio and video for presenting in an XR immersive experience. The attendee 204 may control aspects of the XR immersive experience such as audio volume and playback such as rewind and fast forward. In an embodiment, the conference overview 212 includes at least a portion of live content that is combined with recorded content.

After playing the virtual conference overview 212 to the attendee, the itinerary 210 for both the first tier 206 and the second tier 208 includes a meeting 214 with X Corporation. The meeting 214 may be presented in the virtual experience in any suitable format. In the example of FIG. 2A, the virtual experience proceeds to a separate virtual room 230 where the attendee 204 meets virtually with a representative 232 of X Corporation. This presentation to the attendee 204 may include any suitable features and information. In one example, a human interviewer carrying audio and video equipment enters an actual room at a facility occupied by a human as the representative 232. The human interviewer interviews the representative 232 and asks any suitable questions. The interview including audio and video is recorded and stored for subsequent access by the system to provide the immersive experience to the attendee 204. In another example, the interview is created in part using computer generated using computer generated imagery (CGI). The CGI interview may include a human representative 232 or the representative 232 may be computer generated and animated as well. Use of computer generation techniques allows subsequent modification of the meeting 214 with X Corporation.

In the first tier 206, the meeting 214 with X corporation is followed in the itinerary 210 by a demonstration 216 for product A. The attendee 204 participating in the immersive experience is conducted to a room 236 within the experience. Within the room 236, a demonstration 216 of a product or service is provided to the attendee 204. In some embodiments, the demonstration 216 is provided by a sponsor in return for a sponsorship fee paid by the sponsor to the organization arranging the virtual conference 202. The sponsor may find value in providing demonstrations at the virtual conference 202 because the virtual conference is attended by attendees like attendee 204 with a particular and current interest in the subject matter of the virtual conference 202. Such attendees may be particularly open to receiving information about products and services related to the conference subject matter. The demonstration 216 may be provided to the attendee 204 in any suitable format.

Following the product demonstration 216, the itinerary for the first tier 206 directs the attendee 204 to a meeting 218 with Y Corporation. In the second tier 208, the attendee is passed according to the itinerary 210 directly from the meeting 214 with X Corporation to the meeting 218 with Y Corporation. The transition to the meeting 218 may appear to the attendee in the immersive experience in any suitable manner, such as walking through a busy conference center surrounded by other virtual attendees or avatars for other attendees.

In the case of both the first tier 206 and the second tier 208, the attendee 204 may be shown an advertisement. The advertisement may take any format including an XR immersive experience that is consistent with the immersive experience provided for the virtual conference. The advertisement may be selected in any suitable manner such as randomly or according to a user profile or know interests of the user associated with the attendee 204. The advertisement may be provided by a sponsor who pays the organizer of the virtual conference 202 for the advertising time and space. The advertising may be related to the subject matter of the virtual conference 202 or may be related to another product or service.

The meeting 218 with Y Corporation may be conducted in any suitable fashion, similar to the meeting 214 with X Corporation. The attendee 204 is in a virtual room 238 with a representative 240 of Y Corporation. The meeting 218 may be in the form of a prerecorded interview with the representative talking to a human recording the interview. The interview may be recorded and stored for subsequent retrieval by the attendee 204.

In another example, the representative 240 is associated with a human who attends the virtual conference 202 virtually at the same time as the human user associated with the attendee 204. The human associated with the representative 240 may be employed by Y Corporation in a suitable capacity such as sales or product development. The representative 240 and the attendee 204 can talk together through the virtual experience. The representative 240 can answer questions and provide additional information within the virtual experience, such as calling up files or other data containing video, graphics, audio or text to provide information to the attendee 204. If appropriate, the two participants in the meeting 218 can virtually travel to another location, such as a factory or sales center of Y Corporation, though the medium of the virtual experience. The representative 240 can provide highly detailed and focused information to the attendee 204. The representative 240 and the attendee 204 can thus collaborate in a live interaction in the meeting 218 within the medium of the virtual experience.

Following the meeting 218, the attendee 204 is conducted on the first tier 206 the itinerary 210 to a demonstration 222 of product B in a room 242 with a representative 244. Similar to the demonstration 216 of product A, the demonstration 222 of product B may be conducted in any suitable manner within the immersive experience. Following the demonstration 222 of product B, the attendee 204 is conducted to a meeting 220 with Z Corporation. The attendee 204 on second tier 208 passes directly from the meeting 218 with Y Corporation to the meeting 220 with Z Corporation. The attendee 204 may be shown an advertisement at any time on either first tier 206 or second tier 208.

The meeting 220 with Z Corporation may be conducted in any suitable manner, such as by recording an interview in room 246 with a representative 248 of Z Corporation, or by connecting the representative 248 with the attendee 204 live but virtually through the virtual experience.

Following the meeting 220 with Z Corporation, the attendee 204 according to itinerary 210 proceeds to a conference conclusion session 226. The conference conclusion session 226 may have the form of a wrap-up to the conference, with remarks given by an organizer and provision of additional information. Further, prizes may be awarded to attendees including the attendee 204. For example, the conference conclusion session 226 may include games of chance, a raffle or just the provision of swag or gifts to attendees. Provided items may include sponsored items such as mouse pads or tote bags with corporate logos and product information. The prizes or gifts may take any form including electronic form such as coupons or vouchers that may be emailed to the attendee 204 or retrieved from a network accessible site such as a web site, or a physical object. Since the attendee 204 is attending the virtual conference virtually, though the immersive experience, prizes that have the form of a physical object, such as a mousepad or thumb drive, will be physically sent to the human associated with the attendee 204. The prizes may be mailed or sent by courier.

The embodiment of virtual conference 202 shown in FIG. 2A is intended to be exemplary only. The method 200 illustrates selection of multiple discrete segments or experiences such as meeting 214, meeting 218 and meeting 220, as well as product demonstration 216 and product demonstration 222, that may be combined into a playlist or itinerary 210. The segments may be selected by a user or selected automatically for the user based on, for example, user interests. The segments of the playlist or itinerary may be ordered in any suitable order with the order selected by the user or selected automatically.

Further, the segments of the playlist or itinerary may be presented to the user or attendee 204 according to any suitable format. For example, an XR immersive experience may form a default format. But in some particular examples or some particular segments, other formats may be preferred or necessary or appropriate. For example, if the user does not have available an XR headset, the user may elect an AR or VR format, or switch to another non-immersive format such as mp4 video or even mp3 audio only, with no video. The format selection may be made manually by the user or a participant at the virtual conference 202, such as a subject of an interview. In other examples, the format selection may be made automatically by handshaking or conflict resolution of the equipment used by the user or attendee 204 and the equipment which presents the virtual conference 202 or another event.

Taken together, the segments, when experienced through an immersive experience, mimic a real-world conference or other actual event, without the need to travel to the actual event. Interactions are handled virtually, through a central data processing system. Other embodiments use a cloud-based, distributed network architecture to enable collaboration between conference attendees.

The meetings and product demonstrations that the attendee 204 experiences at the virtual conference may be substituted or supplemented with any combination of other activities that may be enabled by the immersive experience and XR or other equipment of the user. Also, instead of a virtual conference 202, the attendee 204 could attend any suitable virtual event such as a virtual concert. An itinerary such as itinerary 210 may be prepared for the event attendee 204 including pre-recorded experiences or live experiences provided though the immersive experience. The user associated with the attendee 204 may select the segments or experiences or they may be automatically selected for the user, and advertisements may be automatically selected and provided to the user as well. Any amount of tiering, providing access to additional features or experiences, may be provided as well.

FIG. 2B is a block diagram illustrating an example, non-limiting embodiment of a system 250 functioning within the communications network 125 of FIG. 1. The system 250 may provide access to a virtual event with custom event playlists for a user to experience through a virtual medium such as an immersive experience. The system 250 in the illustrated embodiment includes a custom virtual event system 252, a user database 254, an experience database 256, recording equipment 258, a promotion server 260 and an advertising server 262. Other embodiments may include other components, additional components, or alternative components according to particular design requirements.

The custom virtual event system 252 provides access to one or more virtual events such as the virtual conference 202 of FIG. 2A. Any virtual event may be accommodated, including trade shows such as car, boat, and recreational vehicle (RV) shows, concerts, conferences, fairs, rodeos, circuses, or any situation where people gather for an event. The virtual events may be presented to one or more users such as user 264. In an embodiment, user 264 has access to XR equipment such as XR headset 266. The XR equipment communicates with the custom virtual event system 252 over a network such as the internet. A single user such as user 264 may participate alone in a virtual experience. In other embodiments, multiple users such as user 264 may participate jointly in a virtual experience, such as attending the same conference at the same time. In still other embodiments, multiple users such as user 264 may collaborate in a virtual experience, such as the representative 240 of Y Corporation collaborating in a common virtual experience with the attendee 204 in FIG. 2A.

The custom virtual event system 252 may be implemented in one or more data processing systems including one or more memory devices and one or more processors. In some embodiments, the custom virtual event system 252 is implemented in a centralized location accessible over a network such as the internet. In other embodiments, the custom virtual event system 252 is implemented as a cloud computing system with processing of data distributed over several processing elements in data communication over a network.

The custom virtual event system 252 includes a user interface 268 for data communication with user equipment such as the XR headset 266 and the user database 254. The user interface 268 provides data communication for a variety of devices such as the XR headset 266 over one or more networks such as the internet. The user interface 268 further provides data communication with the user database 254 to store in the user database 254 user information obtained from the user 264 or from other sources.

The user database 254 stores user information about users such as the user 264. The user information may include a user profile with information such as the user's identification, affiliation, interests including professional interests and other personal interests. The user information may be obtained from any source such as forms or questionnaires filled out by the user 264 or provided by the user 264 upon registration for an event with the custom virtual event system 252. The user information may be obtained from third party sources and my include, for example, browsing information. The user information of the user database 254 may be used for targeting information to the user including events, promotional material, and advertising. The user information of the user database 254 may be used to automatically select a playlist or itinerary of segments for a user to virtually attend through the custom virtual event system 252.

The experience database 256 stores data defining one or more immersive experiences that may be presented to users such as the user 264. The data for the immersive experiences may originate from any source including participants in an event such as conference attendees or organizations that sponsor, organize and promote an event. The data for the immersive experience may be recorded and received from recording equipment 258 and stored in the experience database. The recording equipment 258 may record video and audio in any suitable format or a combination of formats for playback in an immersive experience. When a user such as user 264 is involved in an immersive experience, the experience data is retrieved from the experience database, composited into the immersive experience, and provided to the user equipment such as XR headset 266. Based on segments in the immersive experience, such as interaction among users, the experience data for an immersive experience may be updated. Updated data is written by the custom virtual event system 252 to the experience database 256. Based on the updated data, the immersive experience may be modified for either the current playback or for a future playback.

The custom virtual event system 252 further includes an artist interface 270 adapted for data communication with a data processing system of an artist 272. The artist 272 may provide any sort of content for inclusion in a segment presented by the custom virtual event system 252. In an example, the event is a concert attended by one or more users such as user 264. The artist 272 provides music in any suitable format to the artist interface 270 for inclusion in the concert by the custom virtual event system 252. For example, the content may be a recorded video with music showing the artist performing. The custom virtual event system 252 composites the video into an immersive experience. The custom virtual event system 252 places the user 264 into the immersive experience to enjoy the concert. If tiering is enabled, the custom virtual event system 252 may make available to the user 264 various additional features such as improved virtual seating and virtual access to a backstage segment. In some embodiments, the artist 270 may engage in a live virtual backstage segment using XR equipment to meet attendees such as user 264.

The custom virtual event system 252 further includes a promotional interface 274 for data communication with the promotional server 260. The promotional server 260 may provide data and information for inclusion in a virtual event curated by the custom virtual event system 252. In the example of FIG. 2A, the product A demonstration 216 and the product B demonstration 222 may be produced under control or direction of the promotional server 260. The promotional server 260 stores data for use by the custom virtual event system 252 in preparing promotional segments and materials for an event. The promotional server 260 may be operated by the operator of the custom virtual event system 252 or by a third party. Data received by the custom virtual event system 252 from the promotional server 260 may be used to composite one or more segments by the custom virtual event system 252 for inclusion in an immersive experience of virtual segments attended by a user such as user 264.

The custom virtual event system 252 further includes an advertiser interface 276 for data communication with the advertiser server 262. The advertiser server 262 may provide advertisements for inclusion in an immersive experience of a virtual segment attended by the user 264. The advertiser server 262 may select advertisements in any suitable fashion. In embodiments, the advertiser server 262 has access to user information such as the user information stored in the user database 254. The advertiser server 262 uses the user information for selecting advertisements of interest to the user 264. During playback of an immersive experience of a segment, the custom virtual event system 252 provides the advertisements for hearing or viewing by the user 264 in the immersive experience. For example, in the context of FIG. 2A, as the user is led on the itinerary 210 from room 230 to room 238, an advertisement selected for the user may appear on a virtual wall for viewing by the user in the immersive experience. In another example, an audio advertisement, such as a commercial jingle, may be played as background noise in the immersive experience. In yet another example, the user 264 in the immersive experience may be required to stop and view an advertisement and interact with the advertisement in some fashion, such a by clicking an acknowledgement or providing contact information. The advertisement may also provide a game or quiz or other fun interaction for the user 264. Such engagement allows the advertiser server 262 to record an impression for the advertisement. Sponsors who place advertising on the advertiser server 262 may pay a price per impression served, so recording the impression allows the sponsor to be charged. Simply showing the advertisement to the user or playing the jingle in the immersive experience may allow recording an impression as well.

The embodiment of the custom virtual event system 252 is intended to be exemplary only. Other embodiments are envisioned and may include a wide variety of modifications to perform similar functions and provide similar benefits.

FIG. 2C depicts an illustrative embodiment of a method 280 in accordance with various aspects described herein. The method may be used in conjunction with a system for providing virtual access to an event such as a concert, conference or other event where people normally gather together. The system and the method 280 enable persons to attend the event via an immersive experience such as through an XR headset.

At block 282, a user may register for the event. In an embodiment, the user accesses a website provided by a sponsor of the event. For example, if the event is a concert, the website may be associated with a performing artist presenting the event or with a promoter of the event. If the event is a conference, the website may be associated with an organization sponsoring or presenting the conference. Registration may include providing identification information, contact information such as home address or business address and email address. In an embodiment, the user may be asked to complete registration by filling out a questionnaire that collects information about the user's interests. Such information may be related to the user's interest in the topic of the conference or other event. Such information may be related to the user's interests more generally such as hobbies and activities.

In some embodiments, registering for the event at block 282 may include determining a tier at which the user participates in the event. Participating at a higher tier may cost the user a higher registration fee or may require that the user respond to a questionnaire or respond to a more detailed questionnaire, or in general give up a greater consideration. Participating at the higher tier may provide additional benefits relative to a lower tier, such as access to segments not open to the lower tier registrants or the receipt of a prize after the event. Also, participating at the higher tier may provide a benefit by allowing the user to avoid aspects of the event such as advertising or promotional materials.

At block 284, a set of segments is selected to form a playlist or itinerary for the user at the event. It is assumed that there are many segments available, only some of which are of interest to the user or in which the user has time to participate. For example, a virtual conference on a particular technical topic may have dozens of presentations and sponsor booths and meet-and-greet opportunities available. The user can only sign up for a limited number of them, perhaps 6 or 8 at most. In another example involving a virtual concert, the showbill may include a dozen bands but the user only cares for two or three bands, or the show is performed by a single band but the band's catalog includes dozens of songs. At block 284, the many available choices are limited to just a few.

In a first embodiment, the user may manually select the segments for the user's playlist. For example, the use may be presented with a webpage with a list of segments to be checked or otherwise selected for inclusion on the playlist. An automated system may make suggestions to the user for the user to approve or decline. In a second embodiment, the automated system may select segments for the user's playlist. The selection may be based on user information and the automated system may retrieve from any suitable source information about the user. For example, a questionnaire filled out at the time of registration may be a source of user information. Third-party sources may be used as well, such as the user's online browsing history of professional reading or personal activities.

The result of block 284 is a playlist or itinerary of segments or activities within the overall event that the user will participate in. The user participates in the activities in some embodiments by entering an immersive experience using an XR headset or suitable equipment. Within the immersive experience, the user is exposed to the playlist of segments in a sequence. The segments may be prerecorded, with data forming the immersive experience being retrieved from a database and composited for transmission to the XR equipment of the user. The segments may include a live component, in which the user interacts with other participants in the event, such as the artist at the concert. At block 286, the event is begun in the immersive experience.

At block 288, the user proceeds to a next segment according to the playlist or itinerary. At a virtual conference, the next segment may be a meeting with a representative of a service provider company of which the user is a customer, or a group presentation about a particular topic. At a virtual conference, the next segment may be a next song by the performers onstage. At a virtual theatrical presentation, the next segment may be a next act in the play.

In some embodiments, as the user participates in the segment, the method may include a feature of detecting user response to the segment. This may be done in any suitable manner, such as by asking the user to fill out a survey after the event ends. In an embodiment, this may be done by monitoring the user's physical response, such as where the user's eyes are focused or the user's heart rate or breathing rate. In a further step, this may include modifying the segment based on the user's response. For example, a portion of the playback of the segment may be omitted or may be revised based on the user's response.

Following completion of the next segment, at block 290, the user may be subject to a promotional segment. A promotional segment has a main purpose to promote a product or service that may be related to the topic of the event. The promotional segment may be selected by the user for addition to the playlist because the promoted product or service is of interest. The promotional segment may be added to the user's playlist because the organizer of the event requires it or recommends it for the user based on user information.

At block 292, it is determined if there are more segments on the user's playlist or itinerary. If so, at block 294, it is determined if the user's participation in the event is subject to tiering. In a first example, the user is in a first tier and is obliged to view advertisements before proceeding to the next segment. At block 296, the advertisement is provided to the user within the immersive experience. The advertisement may be selected for the user based on user information or interests. In some embodiments, advertisers may bid in an auction on the opportunity to fill an impression formed by the need to provide an advertisement to the user. Control returns to block 288. If, at block 294, the user is in a tier that does not require viewing advertisements, control returns to block 288.

If, at block 292, there were no more segments on the user's playlist or itinerary, control proceeds to block 298 where prizes and awards and other follow-up materials are sent to users including the user. Block 298 may include sending an email or a website coupon to a computer account of the user for collecting the prize. Block 298 may further include mailing one or more physical objects to the user as a thank you or in recognition of the user's participation in the conference or other event. The prize sent at block 298 may be responsive to receiving the user's registration information (block 282).

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

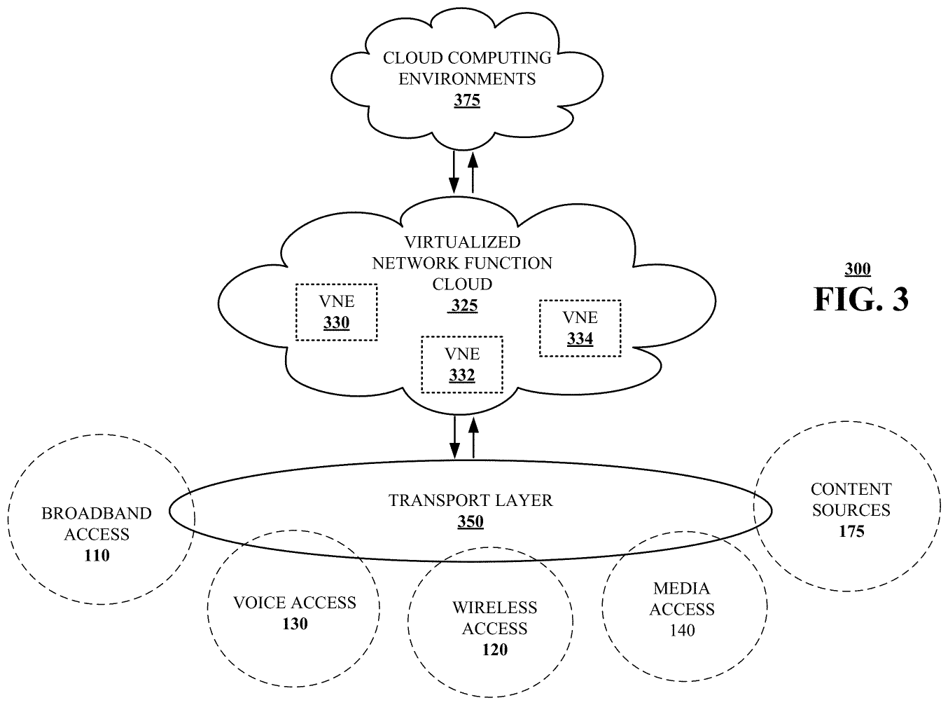

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of method 200, system 250, and method 280 presented in FIGS. 1, 2A, 2B, 2C, and 3. For example, virtualized communication network 300 can facilitate in whole or in part enabling a user to virtually attend an event such as a conference or concert without being physically present in a space with other attendees.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

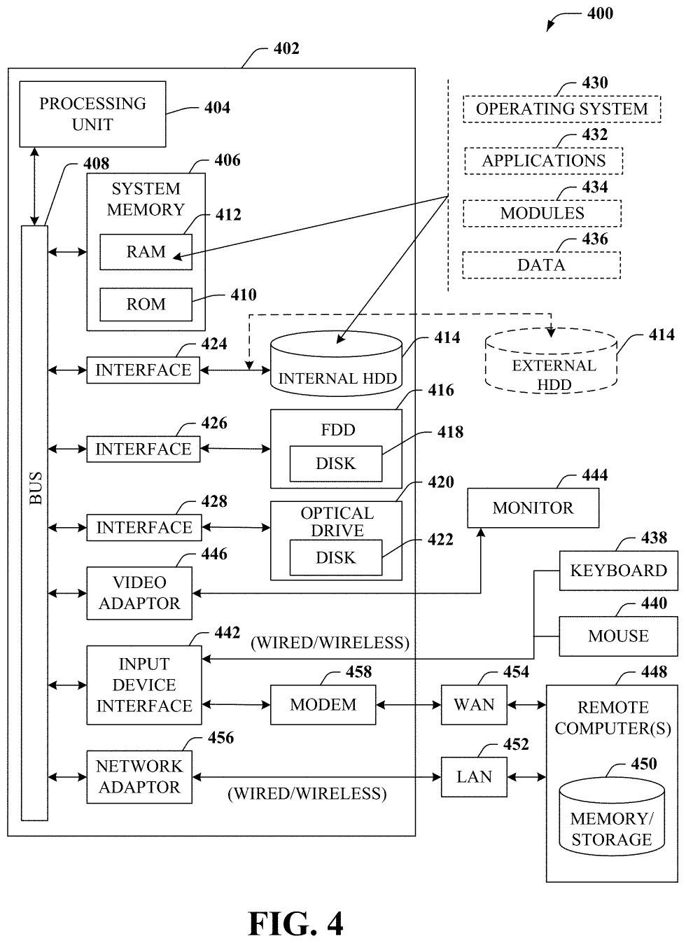

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part enabling a user to virtually attend an event such as a conference or concert without being physically present in a space with other attendees.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory”herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

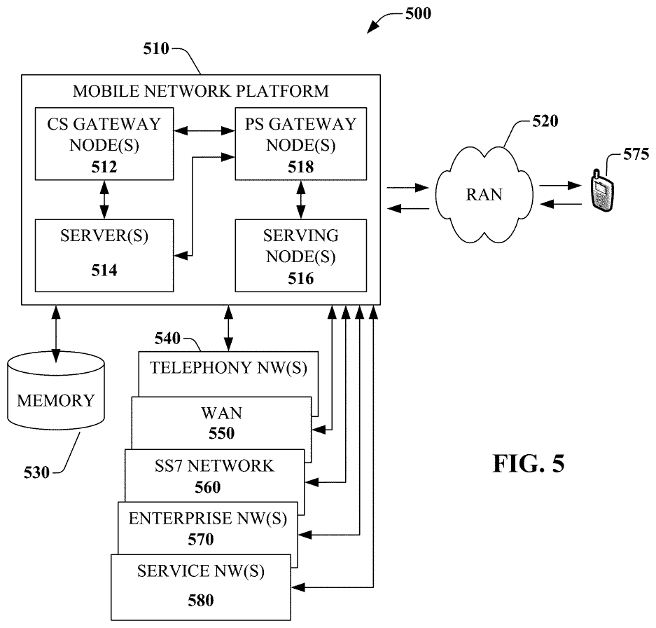

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part enabling a user to virtually attend an event such as a conference or concert without being physically present in a space with other attendees. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

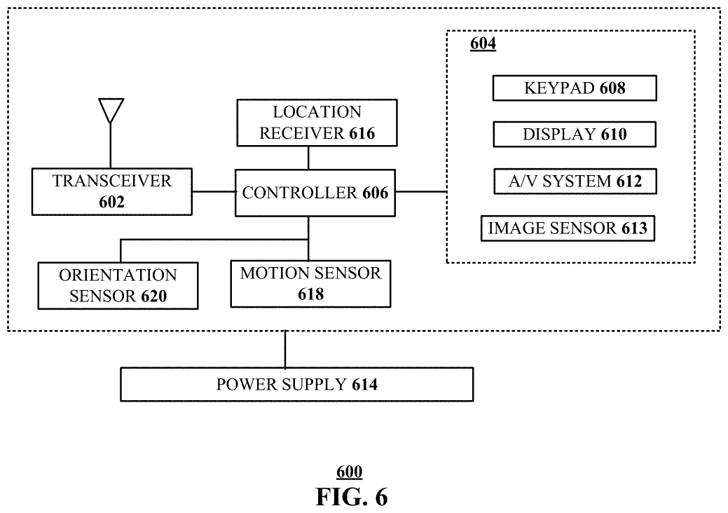

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part enabling a user to virtually attend an event such as a conference or concert without being physically present in a space with other attendees.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
registering a user to participate in a virtual event;
creating a user playlist for user participation in the virtual event, wherein the user playlist comprises a sequence of segments to be presented to the user in an immersive experience of the virtual event;
providing a segment of the sequence of segments to the user in the immersive experience;
detecting a user response to the segment; and
modifying the segment for future presentations of the segment, wherein the modifying is based on the user response to the segment.

2. The device of claim 1, wherein the registering the user to participate in the virtual event comprises:
presenting to the user a registration website;
presenting to the user on the registration website a list of segments to be presented in the virtual event;
receiving from the user a selection of user segments of interest to the user, forming selected user segments; and
arranging the selected user segments to form the user playlist.

3. The device of claim 2, wherein the creating a user playlist comprises:
retrieving user interest information;
selecting one or more promotional segments based on the user interest information; and
arranging the one or more promotional segments to form the user playlist.

4. The device of claim 1, wherein the creating a user playlist comprises:
retrieving user interest information;
selecting one or more segments to be presented to the user in the immersive experience, wherein the selecting is based on the user interest information; and
arranging the one or more segments to be presented to form the user playlist.

5. The device of claim 1, wherein the operations further comprise:
retrieving user interest information; and
selecting one or more advertisements to be presented to the user in the immersive experience, wherein the selecting is based on the user interest information.

6. The device of claim 5, wherein the operations further comprise:
determining tiering information for the user; and
omitting presentation of advertisements to the user in the immersive experience based on the tiering information.

7. The device of claim 1, wherein the virtual event comprises a conference for virtual participation by attendees including the user and wherein the operations further comprise:
recording an interview with a conference presenter;
storing data defining an immersive experience of the interview;
including the interview on the user playlist; and
playing back the interview in the immersive experience of the virtual event.

8. The device of claim 7, wherein the operations further comprise:
recording a product demonstration of a product or service;
storing data defining an immersive experience of the product demonstration;
including the product demonstration on the user playlist; and
paying back the product demonstration in the immersive experience of the virtual event.

9. The device of claim 8, wherein the operations further comprise:
determining that the user has viewed the product demonstration; and
sending a prize to the user in exchange for viewing the product demonstration.

10. The device of claim 1, wherein the virtual event comprises a virtual concert for viewing by attendees including the user and wherein the operations further comprise:
determining tiering information for the user; and
determining a user vantage point for the user based on the tiering information.

11. The device of claim 10, wherein the creating a user playlist for user participation in the virtual event comprises:
selecting a sequence of songs by an artist to be presented to the user; and
offering to the user a back-stage experience of meeting the artist based on the tiering information.

12. The device of claim 11, wherein the operations further comprise:
receiving from the user an indication to share the user playlist with one or more designated persons; and
communicating information about the user playlist to the designated persons.

13. The device of claim 11, wherein the providing a segment of the sequence of segments to the user in the immersive experience comprises providing data for the immersive experience to an extended reality (XR) headset worn by the user and wherein the operations further comprise:
detecting a user gaze of the user within the XR headset;
determining a user level of interest in the segment;
modifying the segment based on the user level of interest, forming a modified segment; and
storing data defining the modified segment for subsequent presentation in an immersive experience.

14. A non-transitory, machine-readable medium, comprising executable instructions that, when executed by a processing system including a processor, facilitate performance of operations, the operations comprising:
retrieving user information for a user participating in a virtual conference;
creating a user playlist for the user for the virtual conference, wherein the creating the user playlist comprises arranging a sequence of conference segments to be presented to the user in an immersive experience of the virtual conference;
providing data defining a segment of the sequence of conference segments to immersive experience hardware of the user;
detecting a user response to the segment, wherein the detecting a user response comprises detecting a user gaze of the user within the immersive experience hardware of the user;
automatically modifying the segment based on the user response, forming a modified segment; and
storing data defining the modified segment.

15. The non-transitory, machine-readable medium of claim 14, wherein the creating a user playlist for the user comprises:
retrieving user information about the user;
automatically selecting prerecorded conference segments based on the user information; and
arranging the prerecorded conference segments to form the sequence of conference segments.

16. The non-transitory, machine-readable medium of claim 15, wherein the operations further comprise:
selecting one or more advertisements to be presented to the user in the immersive experience, wherein the selecting is based on the user information.

17. The non-transitory, machine-readable medium of claim 16, wherein the operations further comprise:
determining tiering information for the user;
omitting presentation of advertisements to the user in the immersive experience based on the tiering information; and
providing access to additional conference events of the virtual conference based on the tiering information.

18. A method, comprising:
registering, by a processing system including a processor, a user to participate in a virtual event, wherein the registering a user comprises receiving user information about the user at a website;
selecting, by the processing system, a plurality of event segments based on the user information, the plurality of event segments to be presented to the user in an immersive experience of the virtual event through immersive experience hardware worn by the user;
arranging, by the processing system, the plurality of event segments into a user playlist, the user playlist forming an itinerary for user participation in the virtual event;
selecting, by the processing system, one or more advertisements, the one or more advertisements to be presented to the user in an immersive experience of the virtual event, wherein the selecting one or more advertisements is based on the user information about the user;
determining, by the processing system, that the user has viewed at least one event segment of the plurality of event segments; and
initiating, by the processing system, sending a prize to the user in response the determining that the user has viewed at least one event segment.

19. The method of claim 18, wherein the virtual event comprises a virtual conference and wherein the selected plurality of event segments comprises:
selecting, by the processing system, a plurality of meetings between the user and conference participants;
selecting, by the processing system, a plurality of product demonstrations for the user; and
including, by the processing system, the plurality of meetings and the plurality of product demonstrations in the user playlist.

20. The method of claim 19, comprising:
determining, by the processing system, tiering information for the user; and
removing, by the processing system, the plurality of product demonstrations from the user playlist based on the tiering information for the user.
